(19) United States
(12) Patent Application Publication
(10) Pub. No.: US 2010/0235702 A1
(43) Pub. Date: Sep. 16, 2010

(54) TRANSMITTER, FILE DISTRIBUTION SYSTEM, FILE DISTRIBUTION CONTROL METHOD AND FILE DISTRIBUTION CONTROL PROGRAM IN SYSTEM

(76) Inventors: JIRO TANIMOTO, Tokyo (JP); Akira Kobayashi, Tokyo (JP)

Correspondence Address: Mr. Jackson Chen, 6535 N. STATE HWY 161, IRVING, TX, 75039, US

(21) Appl. No.: 12/716,340

(22) Filed: Mar. 3, 2010

(30) Foreign Application Priority Data
Mar. 12, 2009 (JP) 2009-059130

(51) Int. Cl. H04L 1/18; G06F 11/14

(52) U.S. Cl. 714/748; 714/E11.113

(57) ABSTRACT

Intended is to avoid retransmission requests from congesting and data retransmission from being disabled.

The receiver 200, when detecting an error whose error correction by an error correcting code is impossible, transmits a request for retransmitting the block to the transmitter 100 through the unicast network 400, and the transmitter 100 receives the retransmission request and selects either the multicast network 300 or the unicast network 400 according to the number of retransmission requests transmitted from the receiver 200 to control simultaneous retransmission of the block.

### INCORPORATION BY REFERENCE

This application is based upon and claims the benefit of priority from Japanese patent application No. 2009-059130, filed on Mar. 12, 2009, the disclosure of which is incorporated herein in its entirety by reference.

### TECHNICAL FIELD

The present invention relates to a transmitter connected to a plurality of receivers through a multicast network and a unicast network, a large capacity file distribution system, and a file distribution control method and a file distribution control program in the system.

### BACKGROUND ART

With the spread of the Internet, there appear services for distributing such contents as motion picture to a terminal device such as a PC (Personal Computer) connected through a network. It has been a common practice to distribute contents formed of these large capacity files by using FTP (File Transfer Protocol).

Since FTP is unicast communication, it is not suitable for distribution to many places. Among suitable for multi-place distribution is multicast communication. Since multicast communication uses connectionless UDP (User Datagram Protocol), such an error as a packet loss has been coped with by duplex transmission (communication satellite) or a forward error correcting code. In such one-way communication as described above, however, no delivery acknowledgement can be obtained to have low certainty.

Known are a method of executing retransmission control such as CFDP (Coherent File Distribution Protocol: RFC1235) and a method with an error correcting code combined with retransmission control such as HSDPA (High Speed Downlink Packet Access) in consideration of the above-described certainty.

Proposed in Patent Literature 1 is a technique of making a retransmission request by a reception node which senses a packet loss without placing a load on a transmission node and all the reception nodes, and the entire network in multicast distribution. Proposed in Patent Literature 2 is a technique which enables efficient data distribution even when data distribution requests are issued from numbers of terminals to a data distribution server.

Patent Literature 1: Japanese Patent Laying-Open No. 2008-5455.

Patent Literature 2: Japanese Patent Laying-Open No. 2005-276079.

All of the above-described methods, however, have retransmission control executed on a packet level basis to have a relatively small volume of data, so that they are not premised on a file of an extremely large capacity such as several GB (Giga Bytes) to several hundreds GB. Network cut-off period is also premised on a short time period.

In file distribution in digital cinema and IPTV (Internet Protocol Television) using communication satellite, in particular, the above-described extremely large volume of data is handled. In addition, since satellite is used in this case, network cutoff might occur on the order of several hours due to effects of weather or the like, which requires retransmission control of a large volume of data. In such services, conventional file distribution methods require an enormous number of retransmission requests and a memory region for retransmission management and have congestion of retransmission requests, so that data might not be retransmitted.

### OBJECT OF THE PRESENT INVENTION

An object of the present invention is to provide a transmitter, a file distribution system, and a file distribution control method and a file distribution control program in the system which prevent retransmission requests from congesting and data retransmission from being disabled by dividing a file of a large capacity on the order of several GB to several hundreds GB to be distributed by multicast into large blocks, for example, on the order of 100 MB to 1 GB according to its file size and executing error recovery control by using an error correcting code on a block basis.

### SUMMARY

A transmitter connected with a plurality of receivers through a multicast network and a unicast network according to an exemplary aspect of the invention, includes a transmission unit which divides a file whose transmission is requested by the receiver into a plurality of blocks on a basis of a predetermined unit independent of a packet and applies an error correcting code to the blocks to distribute an obtained result, and a control unit which, upon receiving a request for retransmission of a block whose error correction is impossible through the unicast network from the receiver having received the block, controls retransmission of the block in question by the transmission unit through the multicast network or the unicast network selected according to the number of the retransmission requests.

A file distribution system including a transmitter and a plurality of receivers according to an exemplary aspect of the invention, wherein the transmitter and the plurality of receivers are connected through a multicast network and a unicast network, and the transmitter comprises a transmission unit which divides a file whose transmission is requested by the receiver into a plurality of blocks on a basis of a predetermined unit independent of a packet and applies an error correcting code to the blocks to distribute an obtained result to the receiver, the receiver comprises a unit which, when detecting, in the block, an error whose error correction by the error correcting code is impossible, transmits a retransmission request for the block to the transmitter through the unicast network, and the transmitter comprises a unit which, upon receiving the retransmission request, selects either the multicast network or the unicast network according to the number of the retransmission requests to control retransmission of the block by the transmission unit.

A file distribution control method of a file distribution system including a transmitter and a plurality of receivers according to an exemplary aspect of the invention, wherein the transmitter and the plurality of receivers are connected through a multicast network and a unicast network, the transmitter comprises the steps of:

dividing a file whose transmission is requested by the receiver into a plurality of blocks on a basis of a predetermined unit independent of a packet and applying an error correcting code to the blocks to distribute an obtained result, and upon receiving a request for retransmission of a block whose error correction is impossible through the unicast network from the receiver having received the block, controlling retransmission of the block in question through the multicast network or the unicast network selected according to the number of the retransmission requests.

A file distribution control program executed on a transmitter connected to a plurality of receivers through a multicast network and a unicast network according to an exemplary aspect of the invention, which causes the transmitter to execute the processing of:

dividing a file whose transmission is requested by the receiver into a plurality of blocks on a basis of a predetermined unit independent of a packet and applying an error correcting code to the blocks to distribute an obtained result, and upon receiving a request for retransmission of a block whose error correction is impossible through the unicast network from the receiver having received the block, controlling retransmission of the block in question through the multicast network or the unicast network selected according to the number of the retransmission requests.

According to the present invention, it is possible to provide a transmitter, a large capacity file distribution system, and a file retransmission control method and a file retransmission control program in the system which prevent retransmission requests from congesting and data retransmission from being disabled by dividing a file of a large capacity on the order of several GB to several hundreds GB to be distributed by multicast into large blocks, for example, on the order of 100 MB to 1 GB according to its file size and executing error recovery control by using an error correcting code on a block basis.

The reason is that a transmission unit of a transmitter divides a file into a plurality of blocks on a predetermined basis independent of a packet and distributes the same with an error correcting code attached and a control unit, when receiving a request for retransmission of a block whose error cannot be corrected from a receiver having received a file through a unicast network, controls retransmission of the block by the transmission unit through a multicast network or the unicast network selected according to the number of retransmission requests.

### BRIEF DESCRIPTION OF THE DRAWINGS

FIG. 1 is a block diagram showing a structure of a large capacity file distribution system according to an exemplary embodiment of the present invention;

FIG. 2 is a diagram showing one example of a data structure of various kinds of tables for use in the large capacity file distribution system according to the exemplary embodiment of the present invention;

FIG. 3 is a sequence diagram (1) showing operation of a transmitter and a receiver of the large capacity file distribution system according to the exemplary embodiment of the present invention;

FIG. 4 is a sequence diagram (2) showing operation of the transmitter and the receiver of the large capacity file distribution system according to the exemplary embodiment of the present invention; and

FIG. 5 is a flow chart showing a detailed procedure of network selection processing by the transmitter according to the exemplary embodiment of the present invention.

### EXEMPLARY EMBODIMENT

Next, an exemplary embodiment of the present invention will be described in detail with reference to the drawings.

### Structure of First Exemplary Embodiment

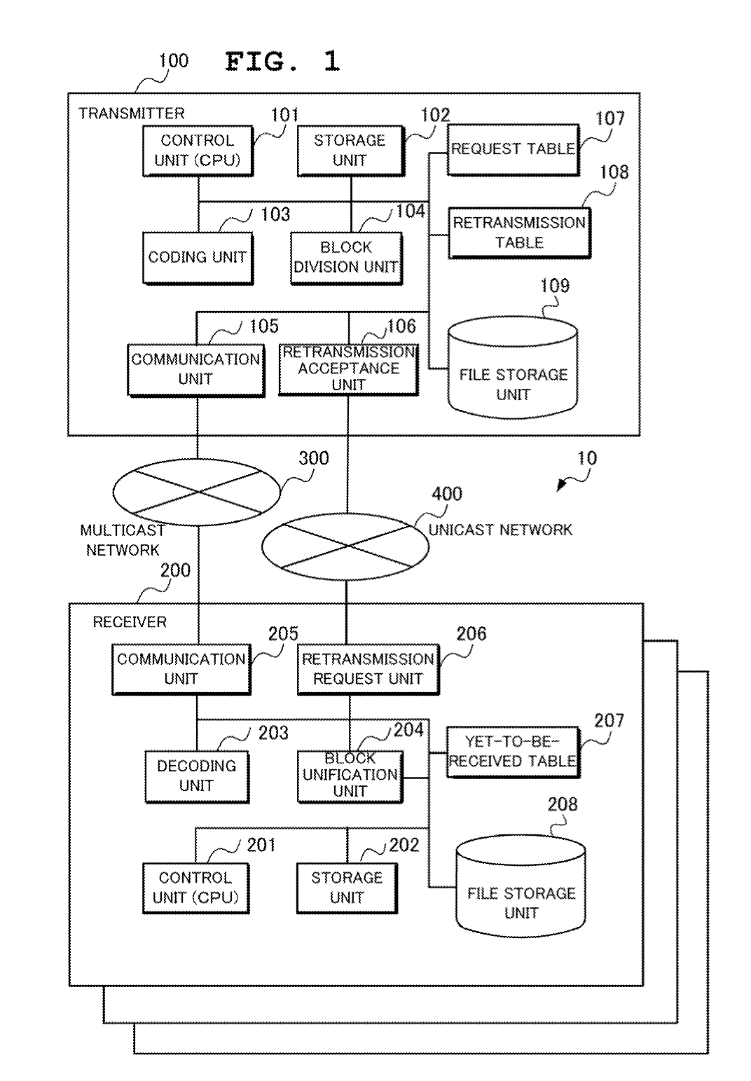

FIG. 1 is a block diagram showing a structure of a large capacity file distribution system 10 according to a first exemplary embodiment of the present invention.

With reference to FIG. 1, the large capacity file distribution system 10 according to the first exemplary embodiment of the present invention has a transmitter 100 and a plurality of receivers 200 connected through a multicast network 300 and a unicast network 400, in which the transmitter 100 is structured to divide a file into a plurality of blocks independent of a packet and applies an error correcting code to them to simultaneously distribute the obtained blocks to the plurality of receivers 200.

As shown in FIG. 1, the transmitter 100, as a unit for selecting either the multicast network 300 or the unicast network 400 according to the number of retransmission requests transmitted from the receivers 200 to control simultaneous retransmission of a block in question, includes a control unit (CPU) 101, a storage unit 102, a coding unit 103, a block division unit 104, a communication unit 105, a retransmission acceptance unit 106, a request table 107, a retransmission table 108 and a file storage unit 109.

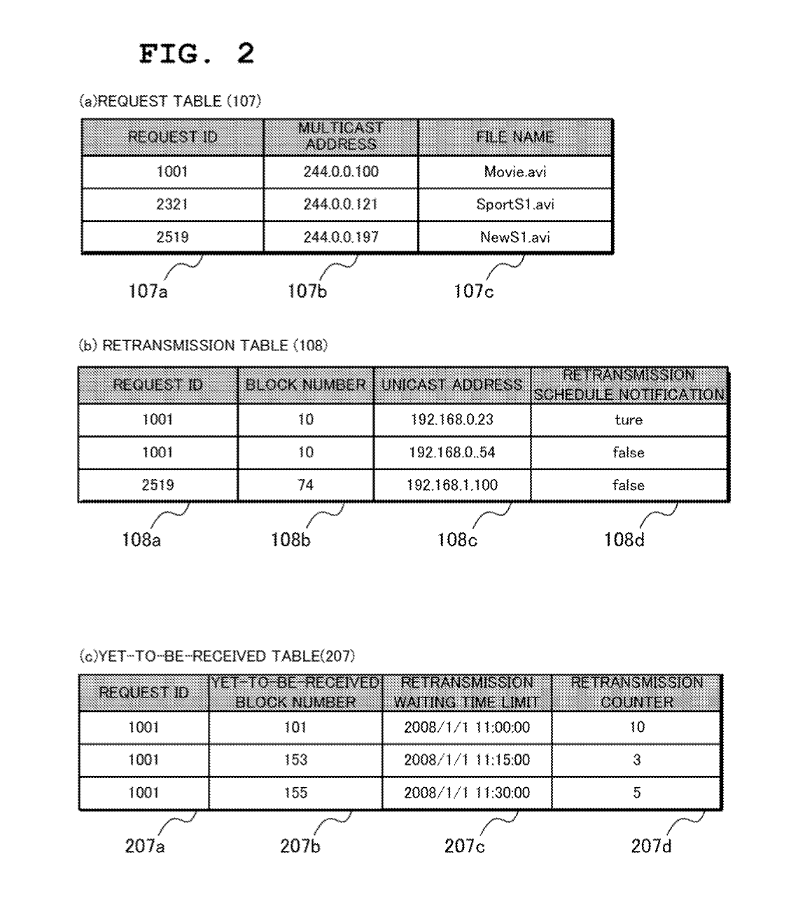

The retransmission table 107, as illustrated in one example of a data structure shown in FIG. 2(a), includes a data field formed of a request ID (107a), a multicast address (107b) and a file name (107c). The retransmission table 108, as illustrated in one example of a data structure shown in FIG. 2(b), includes a data field formed of a request ID (108a), a block number (108b), a unicast address (108c) and a retransmission schedule notification (108d).

On the other hand, the receiver 200, as a unit for transmitting, when detecting an error whose error correction is impossible by an error correcting code, a request for retransmission of a block in question to the transmitter 100 through the unicast network 400, includes a control unit (CPU) 201, a storage unit 202, a decoding unit 203, a block unification unit 204, a communication unit 205, a retransmission request unit 206, a yet-to-be-received table 207 and a file storage unit 208.

The yet-to-be-received table 207, as illustrated in one example of a data structure shown in FIG. 2(c), includes a data field formed of a request ID (207a), a yet-to-be-received block number (207b), a retransmission waiting time limit (207c) and a retransmission counter (207d).

With reference to FIG. 1 and FIG. 2, description will be made of schematic operation of the large capacity file distribution system according to the first exemplary embodiment of the present invention. First, the transmitter 100 having received a file transmission request from the receiver 200 additionally sets a record having description of the request ID (107a) for discriminating the receiver 200 at the request table 107 in order to transmit a file. Then, read a file in question from the file storage unit 109, divide the file into an appropriate size by the block division unit 104 and subject the obtained result to error correction coding by the coding unit 103 to transmit the obtained file to the multicast network 300 through the communication unit 105.

When the block division unit 104 divides a file into an appropriate size here, it is assumed that a file whose capacity is as large as several GB to several hundreds GB is divided into not a packet as a small lump of several hundreds bytes but a large block whose size is on the order of 100 MB to 1 GB.

At the reception of the above-described large-capacity file by the receiver 200, the decoding unit 203 decodes a block received by the communication unit 205, the block unification unit 204 writes the block into the file storage unit 208 and the control unit 205 deletes the relevant record of the yet-to-be-received table 207. When time-out of file reception occurs at the receiver 200, or when an error occurs that cannot be corrected by an error correcting code in the decoding processing at the decoding unit 203, retransmission processing is executed by the control unit 201.

At the time of execution of the retransmission processing, the control unit 201 selects a plurality of small blocks indicated by the retransmission counter (207d) of the yet-to-be-received table 207, updates the value of the retransmission counter (207d) and sends a request for retransmission of these blocks to the transmitter 100 through the retransmission request unit 208 and the unicast network 400.

The transmitter 100 having received the retransmission request transmits a retransmission schedule notification having a retransmission schedule time described in advance to the receiver 200 and updates the retransmission schedule notification (108d) in the record of the relevant block in the retransmission table 108 to “true”. The receiver 200 having received the retransmission schedule notification updates the retransmission waiting time limit (207c) in the yet-to-be-received table 207 to control not to send a retransmission request for the block until the schedule time comes.

When in the transmitter 100, the retransmission acceptance unit 106 receives a retransmission request from, for example, one receiver 200, the control unit 101 selects the unicast network 400 and when the retransmission acceptance unit 106 receives a retransmission request from, for example, two or more receivers 200, the control unit 101 selects the multicast network 300, so that the transmission unit 105 retransmits a relevant block.

Therefore, the transmitter 100 functions as a “transmission unit for dividing a file into a plurality of blocks on a predetermined basis independent of a packet and applying an error correcting code to them to distribute the obtained blocks” as a result of cooperation of the coding unit 103, the block division unit 104 and the communication unit 105 or as a “control unit for, when receiving a request for retransmission of a block whose error cannot be corrected through the unicast network 400 from the receiver 200 having received a file, controlling retransmission of the relevant block by the transmission unit through the multicast network 300 or the unicast network 400 selected according the number of retransmission requests” as a result of cooperation of the control unit 101, the communication unit 105 and the retransmission reception unit 106.

In file transmission completion processing, upon emptiness of a request ID in the yet-to-be-received table 207, the receiver 200 transmits a file reception completion notification to the transmitter 100. The transmitter 100 having received the completion notification deletes a relevant record in the request table 107 to complete the file transmission operation.

### Operation of the First Exemplary Embodiment

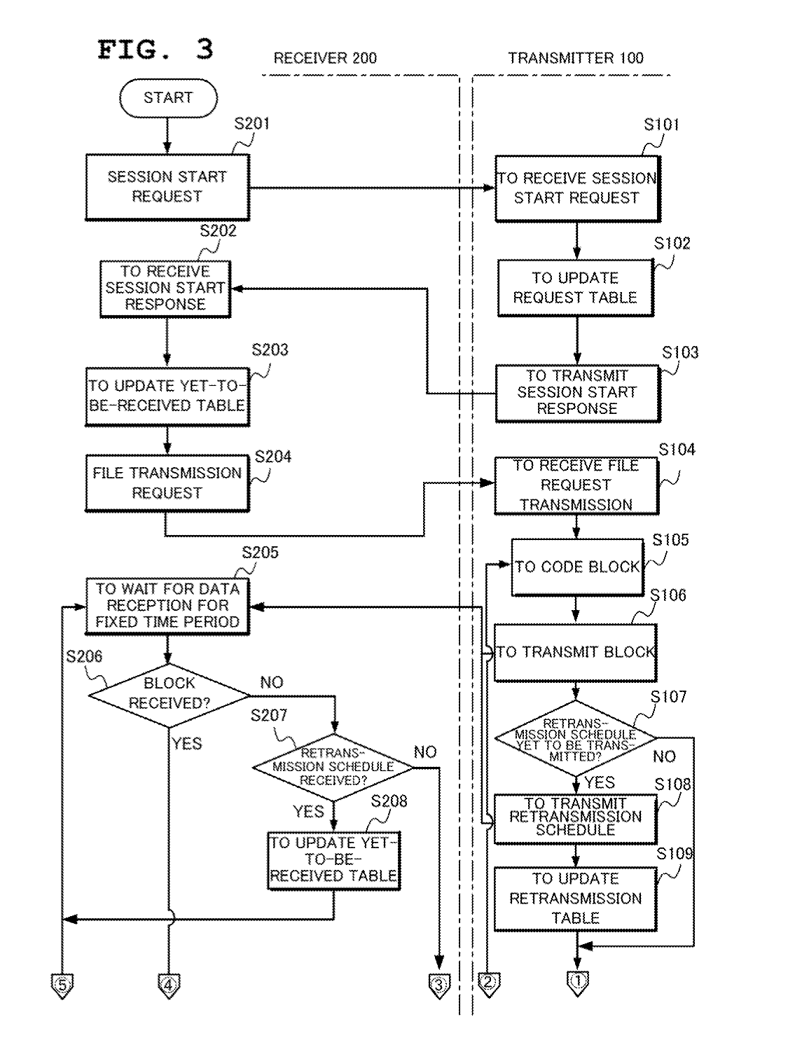

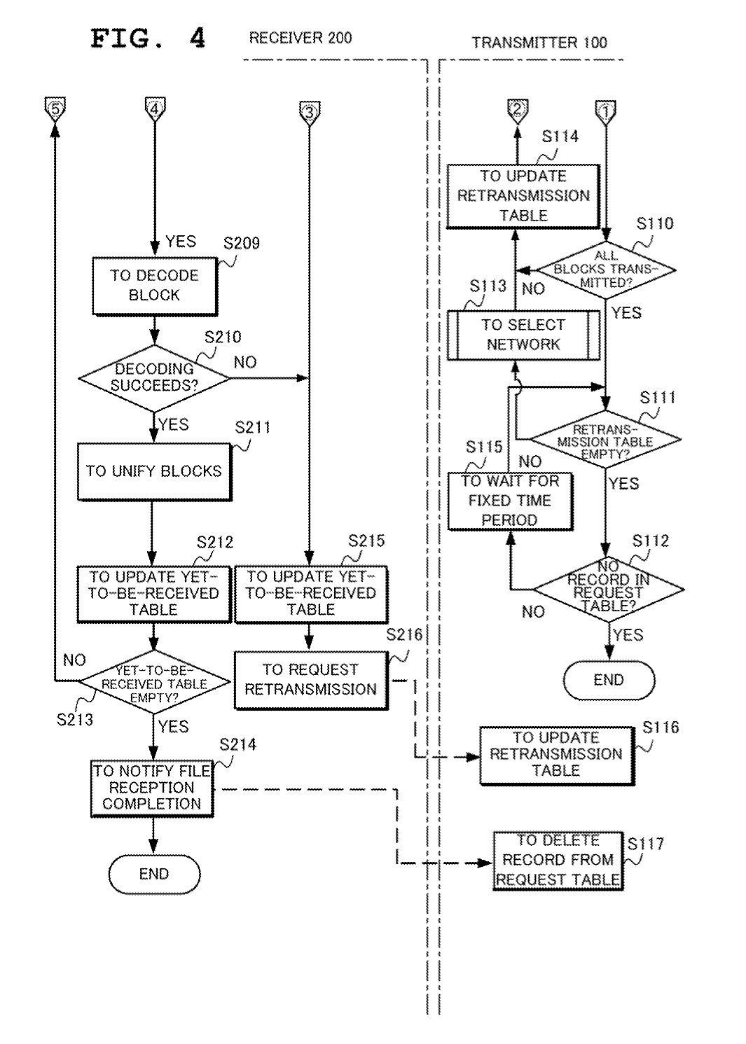

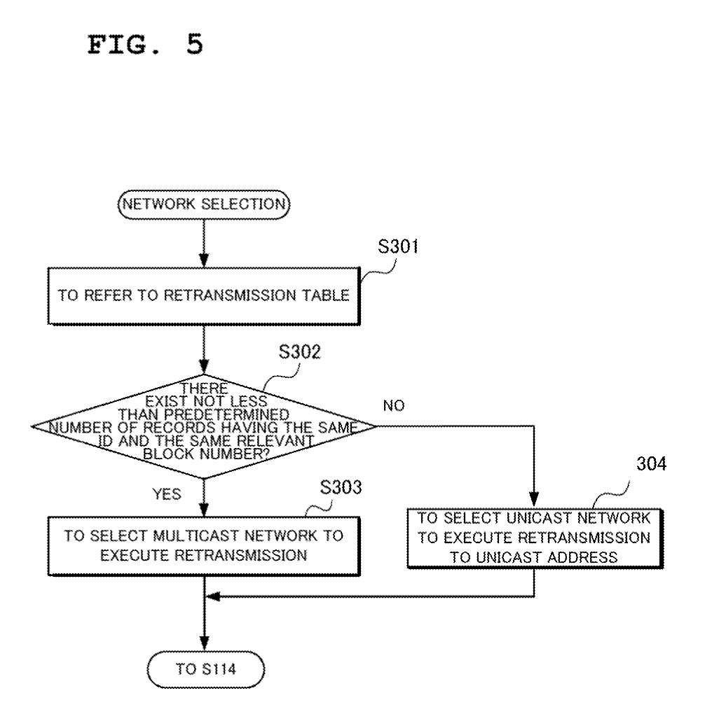

Next, operation of the large capacity file distribution system 10 according to the first exemplary embodiment of the present invention will be described with reference to the sequence diagrams (1) and (2) shown in FIG. 3 and FIG. 4 and the flow chart shown in FIG. 5.

With reference to FIG. 3, in the receiver 200, the control unit 201 first designates a file name to be received and the communication unit 206 transmits a session start request to the transmitter 100 (Step S201).

In the transmitter 100, the communication unit 105 receives the session start request from the receiver 200 (Step S101) and the control unit 101 issues a request ID to be a unique value in the transmitter 100, generates a new record formed of the request ID, a multicast address of a transmission destination and a file name field and additionally sets the same at the request table 107 (Step S102). Subsequently, the transmitter 100 (control unit 101) transmits a transmission parameter formed of a request ID, a file size and a block size as a session start response to the receiver 200 by means of the communication unit 105 (Step S103).

In the receiver 200, the communication unit 205 receives the session start response transmitted from the transmitter 100 (Step S202) and the control unit 201 responsively calculates the number of blocks from the file size and the block size, generates a new record formed of each data field of a request ID, a block number, a retransmission waiting time limit and a retransmission counter and additionally sets as many records as the number of blocks at the yet-to-be-received table 207 (Step S203). Subsequently, the receiver 200 transmits a file transmission request to the transmitter 100 by means of the communication unit 205 (Step S204).

Next, operation of the transmitter 100 at the time of file transmission will be described. In the transmitter 100 having received a file transmission request (Step S104), the control unit 101 reads a file from the file storage unit 109, the block division unit 104 divides the file into predetermined blocks under the control of the control unit 101, the coding unit 103 subjects the blocks to error correction coding (Step S105) and the communication unit 105 transmits the obtained block (Step S106).

After the above-described transmission of the block, in the transmitter 100, the control unit 101 checks the contents of the retransmission table 108 (Step S107). When the retransmission schedule notification has the record of “false”, the control unit 101 selects a plurality of the records and transmits a retransmission schedule notification formed of a block number and a retransmission schedule time to the multicast network 300 (Step S108) and further updates the retransmission schedule notification field of the record to “true” (Step S109).

Subsequently, the control unit 101 determines whether all the blocks are transmitted or not (Step S110 in FIG. 4) and when not all the blocks are transmitted (“No” at Step S110), checks the contents of the retransmission table 108 and when the number of a block scheduled to be transmitted next is in the retransmission table 108, deletes the record (Step S114) to return to the coding processing at Step S105.

In a case where it is confirmed that transmission of all the blocks is completed in the all the blocks transmission determination processing at Step S110 (“YES” at Step S110), even when the transmitter 100 transmits all the blocks, the receiver 200 might not have received a part of the blocks, so that the control unit 101 checks the retransmission table 108 (Step S111). Here, when the determination is made that the contents of the retransmission table 108 are not empty (“No” at Step S111), the control unit 101 selects a plurality of blocks to be retransmitted and selects a network for use in retransmission (the multicast network 300 or the unicast network 400) (Step S113).

At the execution of the above-described network selection processing (Step S113), the control unit 101 refers to the retransmission table 108 (Step S301) as shown in the detailed procedure in FIG. 5 and when there exist not less than a fixed number of records having the same request ID and the same relevant block number with respect to a block to be retransmitted (“YES” at Step S302), selects the multicast network 300 to retransmit the block (Step S303). Conversely, when less than the fixed number of records exist (“NO” at Step S302), the control unit 101 selects the unicast network 400 and retransmits the block to a unicast address in each record (Step S304).

Return the description to the sequence diagrams shown in FIG. 3 and FIG. 4. After the above-described network selection processing (Step S113), the control unit 101 deletes the record of the block to be retransmitted from the retransmission table 108 (Step S114) to return to execution of the block coding processing at Step S105 in FIG. 3.

On the other hand, when the determination is made that the retransmission table 108 is empty (“YES” at Step S111), the control unit 101 determines whether a relevant record exists in the request table 107 (Step S112). When the determination is made that there exists the relevant record (“YES” at Step S112), the control unit 101 recognizes that a retransmission request from the receiver 200 having a block whose retransmission is required is yet to arrive and after waiting for a fixed time period (Step S115), returns to the execution of the retransmission table emptiness determination processing at Step S111. When determination is made that there is no relevant record (“NO” at Step S112), the control unit 101 ends the file transmission operation because it is indicated that a file reception completion notification is received from the receiver 200 as will be described later.

In addition to the above-described operation, the transmitter 100 executes the following operation in response to a retransmission request from the receiver 200. More specifically, in the transmitter 100 having received a retransmission request from the receiver 200, the control unit 101 additionally sets at the retransmission table 108 a record formed of a request ID described in the retransmission request, a block number, a unicast address of the receiver 200 and a retransmission schedule notification field (Step S116). When receiving the file reception completion notification from the receiver 200, the control unit 101 deletes a record having the relevant request ID from the request table 107 (Step S117).

Lastly, operation of the receiver 200 at the file reception will be described. The receiver 200 having sent a file transmission request to the transmitter 100 waits for reception of a block for a fixed time period (Step S205 in FIG. 4) to execute block reception determination (Step S206). When no block is received here (“NO” at Step S206), the control unit 201 checks whether a retransmission schedule notification is received from the transmitter 100 or not (Step S207). When receiving the retransmission schedule notification (“YES” at Step S207), the control unit 201 updates the retransmission waiting period (207c) of the record of the relevant block number in the yet-to-be-received table 207 to a retransmission schedule time of the retransmission schedule notification (Step S208).

On the other hand, when in the block reception determination processing at Step S206, a block is received (“YES” at Step S206), the control unit 201 instructs on block decoding processing by the decoding unit 203 (Step S207). Because an error correcting code is used for coding a file, the decoding unit 203 is allowed to recover an error during file transmission to some extent. Subsequently, the control unit 201 determines a result of the decoding by the decoding unit 203 (Step S210 in FIG. 4) and when the decoding is completed normally (“YES” at Step S210), writes the block into the file storage unit 208 to unify the blocks (Step S211). Furthermore, the control unit 201 deletes a record in the yet-to-be-received table 207 relevant to the number of the received block (Step S212).

Lastly, the control unit 201 determines whether the yet-to-be-received table 207 is empty or not (Step S213) and when it is not empty (“NO” at Step S213), returns to the fixed time period reception data waiting processing of Step S205 shown in FIG. 3. When the yet-to-be-received table 207 is empty (“YES” at Step S213), which is assumed to have received all the blocks, the control unit 201 generates a file reception completion notification and transmits the same to the transmitter 100 through the communication unit 205 (Step S214). In the transmitter 100 having received the file reception completion notification, the control unit 101 deletes the record from the request table 107 (Step S117).

When no retransmission schedule notification is received in the retransmission schedule reception determining processing at Step S207 (“NO” at Step S207) or when decoding fails in the decoding success determining processing at Step S210 (“NO” at Step S210), the control unit 201 abandons the block and selects several records whose values of the retransmission counter (207d) are small with reference to the yet-to-be-received table 207, updates the retransmission counter value to generate a retransmission request (Step S215) and sends a retransmission request formed of the block number and a request ID to the transmitter 100 by means of the retransmission request unit 206 (Step S216). The transmitter 100 having received the retransmission request updates the retransmission table 108 (Step S116).

### Effects of the First Exemplary Embodiment

The large capacity file distribution system 10 according to the present exemplary embodiment enables efficient distribution of a large capacity file even when a network is cut off for a relatively long period of time by dividing a file into blocks, subjecting the same to error correction coding and transmitting the obtained block and in response to a retransmission request from the receiver 200, selecting either the multicast network 300 or the unicast network 400 to retransmit the block in question by the transmitter 100.

The reason is that expansion of a retransmission management region and congestion of retransmission requests can be suppressed not by packet level retransmission control but by retransmission control on a basis of a block having a certain extent of size such as several GB.

In addition, in the large capacity file distribution system 10 according to the present exemplary embodiment, because the receiver 200 receives, decodes and unifies blocks to restructure a file and when file reception time-out or an error which cannot be corrected by an error correcting code occurs, transmits a retransmission request by using the unicast network 400, the transmitter 100 is allowed to distribute a file even when a random error occurs.

The reason is that by subjecting communication data to error correction coding, the receiver 200 is allowed to correct a random error.

The functions that the control unit 101 of the transmitter 100 shown in FIG. 1 has may be realized all in software or at least a part of them may be realized in hardware. For example, the data processing of controlling, when the control unit 101 receives a request for retransmission of a block whose error correction is impossible through the unicast network 400 from the receiver 200 having received a file, retransmission of the relevant block through the multicast network 300 or the unicast network 400 selected according to the number of retransmission requests may be realized by one or a plurality of programs on a computer or at least part of the processing may be realized in hardware.

Although the present invention has been described with respect to the preferred exemplary embodiment and mode of implementation in the foregoing, the present invention is not necessarily limited to the above-described exemplary embodiment and mode of implementation and can be implemented in various modifications without departing from the scope of its technical ideas.

The whole or part of the exemplary embodiments disclosed above can be described as, but not limited to, the following supplementary notes.

(Supplementary note 1) A transmitter connected with a plurality of receivers through a multicast network and a unicast network, comprising a transmission unit which divides a file whose transmission is requested by said receiver into a plurality of blocks on a basis of a predetermined unit independent of a packet and applies an error correcting code to the blocks to distribute an obtained result, and a control unit which, upon receiving a request for retransmission of a block whose error correction is impossible through said unicast network from the receiver having received said block, controls retransmission of the block in question by said transmission unit through the multicast network or the unicast network selected according to the number of said retransmission requests.

(Supplementary note 2) The transmitter according to Supplementary note 1, wherein said control unit selects said multicast network when the number of said retransmission requests is not less than a predetermined number and selects said unicast network when the number is less than the predetermined number.

(Supplementary note 3) The transmitter according to Supplementary note 1, comprising a retransmission table having a record including a request ID of a transmission request for said file whose retransmission is requested by said receiver, the number of said block whose error correction is impossible and a unicast address, wherein

said control unit, at the time of retransmission by said transmission unit, refers to said retransmission table and when a predetermined number of records having the same request ID and the same block number exist, selects said multicast network and when less than the predetermined number of records exist, selects said unicast network to control retransmission by said transmission unit using a unicast address in said record.

(Supplementary note 4) The transmitter according to Supplementary note 3, wherein said control unit,

when receiving a retransmission request from said receiver, adds a record corresponding to a block whose retransmission is requested to said retransmission table, and

deletes a record corresponding to a block whose retransmission is executed by said transmission unit from said retransmission table.

(Supplementary note 5) The transmitter according to Supplementary note 1, comprising a request table having a record including a request ID for discriminating a file transmission request, a multicast address and a file name, which

upon receiving a file reception notification indicative of reception of all the blocks of a file from said receiver, deletes a record of the corresponding file.

(Supplementary note 6) A file distribution system including a transmitter and a plurality of receivers, wherein said transmitter and said plurality of receivers are connected through a multicast network and a unicast network, and

said transmitter comprises a transmission unit which divides a file whose transmission is requested by said receiver into a plurality of blocks on a basis of a predetermined unit independent of a packet and applies an error correcting code to the blocks to distribute an obtained result to said receiver,

said receiver comprises a unit which, when detecting, in said block, an error whose error correction by said error correcting code is impossible, transmits a retransmission request for the block to said transmitter through said unicast network, and

said transmitter comprises a unit which, upon receiving said retransmission request, selects either said multicast network or the unicast network according to the number of said retransmission requests to control retransmission of said block by said transmission unit.

(Supplementary note 7) The file distribution system according to Supplementary note 6, wherein said control unit of said transmitter selects said multicast network when the number of said retransmission requests is not less than a predetermined number and selects said unicast network when the number is less than the predetermined number.

(Supplementary note 8) The file distribution system according to Supplementary note 6, wherein

said transmitter comprises a retransmission table having a record including a request ID of a transmission request for said file whose retransmission is requested by said receiver, the number of said block whose error correction is impossible and a unicast address, and

said control unit of said transmitter, at the time of retransmission by said transmission unit, refers to said retransmission table and when a predetermined number of records having the same request ID and the same block number exist, selects said multicast network and when less than the predetermined number of records exist, selects said unicast network to control retransmission by said transmission unit using a unicast address in said record.

(Supplementary note 9) The file distribution system according to Supplementary note 8, wherein said control unit of said transmitter,

when receiving a retransmission request from said receiver, adds a record corresponding to a block whose retransmission is requested to said retransmission table, and

deletes a record corresponding to a block whose retransmission is executed by said transmission unit from said retransmission table.

(Supplementary note 10) The file distribution system according to Supplementary note 6, wherein said receiver comprises:

a yet-to-be-received table having as many records as the number of blocks each of which records includes a request ID for discriminating a file transmission request, a block number and a retransmission counter indicative of the number of retransmissions, and

a control unit which, when none of errors whose error correction by said error correcting code is impossible is detected in a block received from said transmitter, deletes a record corresponding to the block in question in said yet-to-be-received table, and when an error whose error correction by said error correcting code is impossible is detected in said block, requests said transmitter to retransmit the block in question to update a retransmission counter of a record corresponding to the block in question in said yet-to-be-received table.

(Supplementary note 11) A file distribution control method of a file distribution system including a transmitter and a plurality of receivers, wherein said transmitter and said plurality of receivers are connected through a multicast network and a unicast network, said transmitter comprises the steps of:

dividing a file whose transmission is requested by said receiver into a plurality of blocks on a basis of a predetermined unit independent of a packet and applying an error correcting code to the blocks to distribute an obtained result; and

upon receiving a request for retransmission of a block whose error correction is impossible through said unicast network from the receiver having received said block, controlling retransmission of the block in question through the multicast network or the unicast network selected according to the number of said retransmission requests.

(Supplementary note 12) The file distribution control method according to Supplementary note 11, wherein said transmitter selects said multicast network when the number of said retransmission requests is not less than a predetermined number and selects said unicast network when the number is less than the predetermined number.

(Supplementary note 13) The file distribution control method according to Supplementary note 11, wherein said transmitter, at the time of retransmission of said block, refers to a retransmission table having a record including a request ID of a transmission request for said file whose retransmission is requested by said receiver, the number of said block whose error correction is impossible and a unicast address, and when a predetermined number of records having the same request ID and the same block number exist, selects said multicast network and when less than the predetermined number of records exist, selects said unicast network to execute retransmission using a unicast address in said record.

(Supplementary note 14) The file distribution control method according to Supplementary note 13, wherein said transmitter,

when receiving a retransmission request from said receiver, adds a record corresponding to a block whose retransmission is requested to said retransmission table, and

deletes a record corresponding to a block whose retransmission is executed by said transmission unit from said retransmission table.

(Supplementary note 15) A file distribution control program executed on a transmitter connected to a plurality of receivers through a multicast network and a unicast network, which causes said transmitter to execute the processing of:

dividing a file whose transmission is requested by said receiver into a plurality of blocks on a basis of a predetermined unit independent of a packet and applying an error correcting code to the blocks to distribute an obtained result, and

upon receiving a request for retransmission of a block whose error correction is impossible through said unicast network from the receiver having received said block, controlling retransmission of the block in question through the multicast network or the unicast network selected according to the number of said retransmission requests.

(Supplementary note 16) The file distribution control program according to Supplementary note 15, which causes said transmitter to execute the processing of selecting said multicast network when the number of said retransmission requests is not less than a predetermined number and selects said unicast network when the number is less than the predetermined number.

(Supplementary note 17) The file distribution control program according to Supplementary note 15, which causes said transmitter to execute the processing of, at the time of retransmission of said block, referring to a retransmission table having a record including a request ID of a transmission request for said file whose retransmission is requested by said receiver, the number of said block whose error correction is impossible and a unicast address, and when a predetermined number of records having the same request ID and the same block number exist, selecting said multicast network and when less than the predetermined number of records exist, selecting said unicast network to execute retransmission using a unicast address in said record.

(Supplementary note 18) The file distribution control program according to Supplementary note 17, which causes said transmitter to execute the processing of:

when receiving a retransmission request from said receiver, adding a record corresponding to a block whose retransmission is requested to said retransmission table, and

deleting a record corresponding to a block whose retransmission is executed by said transmission unit from said retransmission table.

What is claimed is:

1. A transmitter connected with a plurality of receivers through a multicast network and a unicast network, comprising:
a transmission unit which divides a file whose transmission is requested by said receiver into a plurality of blocks on a basis of a predetermined unit independent of a packet and applies an error correcting code to the blocks to distribute an obtained result; and
a control unit which, upon receiving a request for retransmission of a block whose error correction is impossible through said unicast network from the receiver having received said block, controls retransmission of the block in question by said transmission unit through the multicast network or the unicast network selected according to the number of said retransmission requests.

2. The transmitter according to claim 1, wherein said control unit selects said multicast network when the number of said retransmission requests is not less than a predetermined number and selects said unicast network when the number is less than the predetermined number.

3. The transmitter according to claim 1, comprising a retransmission table having a record including a request ID of a transmission request for said file whose retransmission is requested by said receiver, the number of said block whose error correction is impossible and a unicast address, wherein
said control unit, at the time of retransmission by said transmission unit, refers to said retransmission table and when a predetermined number of records having the same request ID and the same block number exist, selects said multicast network and when less than the predetermined number of records exist, selects said unicast network to control retransmission by said transmission unit using a unicast address in said record.

4. The transmitter according to claim 3, wherein said control unit,
when receiving a retransmission request from said receiver, adds a record corresponding to a block whose retransmission is requested to said retransmission table, and
deletes a record corresponding to a block whose retransmission is executed by said transmission unit from said retransmission table.

5. The transmitter according to claim 1, comprising a request table having a record including a request ID for discriminating a file transmission request, a multicast address and a file name, which
upon receiving a file reception notification indicative of reception of all the blocks of a file from said receiver, deletes a record of the corresponding file.

6. A file distribution system including a transmitter and a plurality of receivers, wherein said transmitter and said plurality of receivers are connected through a multicast network and a unicast network, and
said transmitter comprises a transmission unit which divides a file whose transmission is requested by said receiver into a plurality of blocks on a basis of a predetermined unit independent of a packet and applies an error correcting code to the blocks to distribute an obtained result to said receiver,
said receiver comprises a unit which, when detecting, in said block, an error whose error correction by said error correcting code is impossible, transmits a retransmission request for the block to said transmitter through said unicast network, and
said transmitter comprises a unit which, upon receiving said retransmission request, selects either said multicast network or the unicast network according to the number of said retransmission requests to control retransmission of said block by said transmission unit.

7. The file distribution system according to claim 6, wherein said control unit of said transmitter selects said multicast network when the number of said retransmission requests is not less than a predetermined number and selects said unicast network when the number is less than the predetermined number.

8. The file distribution system according to claim 6, wherein
said transmitter comprises a retransmission table having a record including a request ID of a transmission request for said file whose retransmission is requested by said receiver, the number of said block whose error correction is impossible and a unicast address, and
said control unit of said transmitter, at the time of retransmission by said transmission unit, refers to said retransmission table and when a predetermined number of records having the same request ID and the same block number exist, selects said multicast network and when less than the predetermined number of records exist, selects said unicast network to control retransmission by said transmission unit using a unicast address in said record.

9. The file distribution system according to claim 8, wherein said control unit of said transmitter,
when receiving a retransmission request from said receiver, adds a record corresponding to a block whose retransmission is requested to said retransmission table, and
deletes a record corresponding to a block whose retransmission is executed by said transmission unit from said retransmission table.

10. The file distribution system according to claim 6, wherein said receiver comprises:
a yet-to-be-received table having as many records as the number of blocks each of which records includes a request ID for discriminating a file transmission request, a block number and a retransmission counter indicative of the number of retransmissions, and
a control unit which, when none of errors whose error correction by said error correcting code is impossible is detected in a block received from said transmitter, deletes a record corresponding to the block in question in said yet-to-be-received table, and when an error whose error correction by said error correcting code is impossible is detected in said block, requests said transmitter to retransmit the block in question to update a retransmission counter of a record corresponding to the block in question in said yet-to-be-received table.

11. A file distribution control method of a file distribution system including a transmitter and a plurality of receivers, wherein said transmitter and said plurality of receivers are connected through a multicast network and a unicast network, said transmitter comprises the steps of:
dividing a file whose transmission is requested by said receiver into a plurality of blocks on a basis of a predetermined unit independent of a packet and applying an error correcting code to the blocks to distribute an obtained result; and
upon receiving a request for retransmission of a block whose error correction is impossible through said unicast network from the receiver having received said block, controlling retransmission of the block in question through the multicast network or the unicast network selected according to the number of said retransmission requests.

12. The file distribution control method according to claim 11, wherein said transmitter selects said multicast network when the number of said retransmission requests is not less than a predetermined number and selects said unicast network when the number is less than the predetermined number.

13. The file distribution control method according to claim 11, wherein said transmitter, at the time of retransmission of said block, refers to a retransmission table having a record including a request ID of a transmission request for said file whose retransmission is requested by said receiver, the number of said block whose error correction is impossible and a unicast address, and when a predetermined number of records having the same request ID and the same block number exist, selects said multicast network and when less than the predetermined number of records exist, selects said unicast network to execute retransmission using a unicast address in said record.

14. The file distribution control method according to claim 13, wherein said transmitter,
when receiving a retransmission request from said receiver, adds a record corresponding to a block whose retransmission is requested to said retransmission table, and
deletes a record corresponding to a block whose retransmission is executed by said transmission unit from said retransmission table.
